(19) United States
(12) Patent Application Publication
(10) Pub. No.: US 2023/0028536 A1
(43) Pub. Date: Jan. 26, 2023

(54) METHOD OF ESTIMATING EMPLOYEE TURNOVER RATES, COMPUTING DEVICE, AND STORAGE MEDIUM

(71) Applicants: HONGFUJIN PRECISION ELECTRONICS (CHENGDU) Co., Ltd., Chengdu (CN); HON HAI PRECISION INDUSTRY CO., LTD., New Taipei (TW)

(72) Inventors: ZI-QING XIA, Chengdu (CN); QIAN-CE HU, Chengdu (CN); MIN CHEN, Chengdu (CN); JING PENG, Chengdu (CN); YI-KUN WANG, Chengdu (CN); RUO-HONG MA, Chengdu (CN)

(21) Appl. No.: 17/550,122

(22) Filed: Dec. 14, 2021

(30) Foreign Application Priority Data
Jul. 23, 2021 (CN) 202110838146.3

(51) Int. Cl. G06Q 10/10; G06K 9/62; G06N 3/08

(52) U.S. Cl. CPC G06Q 10/105; G06K 9/6201; G06K 9/6227; G06K 9/6262; G06N 3/08

(57) ABSTRACT

A method of estimating employee turnover rates obtains original employee data from a preset data source. First data processing is applied to the original employee data to obtain first processed employee data. A training set and a first verification set are selected from the first processed employee data. The training set is used to train a machine learning model to obtain a turnover estimation model. The first verification set is used to verify the turnover estimation model to obtain a first estimation result. The turnover estimation model is optimized according to the first estimation result to obtain an optimized turnover estimation model. Updated employee data and a corresponding employee turnover rate of a second time period are obtained. The method helps to replenish manpower in time and avoids over-recruitment.

### FIELD

The subject matter herein generally relates to computer technology, specifically a method of estimating employee turnover rates, a computing device, and a storage medium.

### BACKGROUND

With the increase in production capacity of labor-intensive companies, labor shortage becomes more apparent and frequent. High employee turnover is a major reason for labor shortage. Estimating an employee turnover rate can help to replenish manpower in time and avoid over-recruitment.

### BRIEF DESCRIPTION OF THE DRAWINGS

In order to more clearly describe the technical solutions in the embodiments of the present disclosure or the prior art, the following will briefly introduce the drawings that need to be used in the description of the embodiments or the prior art. Obviously, the drawings in the following description are only examples. For those of ordinary skill in the art, other drawings can be obtained according to the provided drawings without creative work.

FIG. 1 is a flowchart of a method of estimating employee turnover rates provided in one embodiment of the present disclosure.

FIG. 2 is a block diagram of a computing device implementing the method in one embodiment of the present disclosure.

### DETAILED DESCRIPTION

For clarity, of illustration of objectives, features and advantages of the present disclosure, the drawings combined with the detailed description illustrate the embodiments of the present disclosure hereinafter. It is noted that embodiments of the present disclosure and features of the embodiments can be combined, when there is no conflict.

Various details are described in the following descriptions for better understanding of the present disclosure. However, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments, and are not intended to limit the present disclosure.

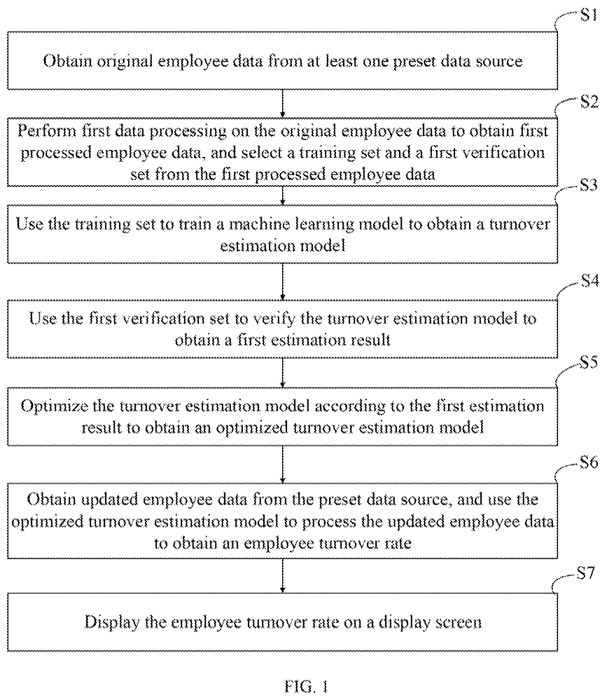

FIG. 1 is a flowchart of a method of estimating employee turnover rates in one embodiment. According to different requirements, the order of the steps in the flowchart may be changed, and some steps may be omitted.

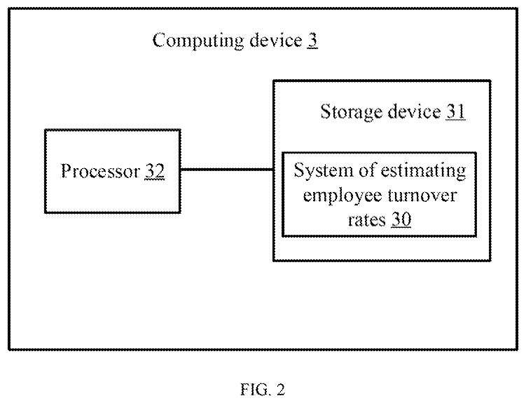

The method may be executed by a computing device (e.g., computing device 3 in FIG. 2). A function of estimating employee turnover rates can be integrated in the computing device 3, or a software development kit (SDK) of estimating employee turnover rates is run in the computing device 3.

In block S1, the computing device obtains original employee data from at least one preset data source.

The computing device may obtain the original employee data from at least one preset database. In one embodiment, the at least one preset database may include an employee information database and an enterprise management database. The original employee data may include attendance information (such as leave time, overtime hours, late or early leaving times, absenteeism, resignation type, time of resignation), basic information (such as gender, birth date, and place of origin, nationality, residential address, whether an employee is from a dual-earner family), job information (such as job number, department, seniority, salary grade, position grade, entry salary, entry manner, type of production line, position, direct supervisor), salary information (such as basic salary, amount of last salary increase, time of last salary increase, performance, allowance) and other related information (such as pay day, pay week, work plan).

In block S2, the computing device performs first data processing on the original employee data to obtain first processed employee data, and selects a training set and a first verification set from the first processed employee data.

In one embodiment, performing first data processing on the original employee data to obtain first processed employee data may include: performing data extraction on the original employee data to obtain extracted employee data; performing data cleaning on the extracted employee data to obtain first anomaly-free data; performing data conversion on the first anomaly-free data to obtain converted employee data; performing data loading on the converted employee data to obtain loaded employee data; performing time-series correlation analysis on the loaded employee data to obtain analyzed employee data; and performing feature coding on the analyzed employee data to obtain the first processed employee data. The computing device may perform the data extraction, the data cleaning, the data conversion, and the data loading using a data warehousing technology.

In one embodiment, performing data extraction on the original employee data may include: extracting data of preset types from the original employee data. The data of the preset types may include the attendance information, the basic information, the job information, the salary information, and the other related information.

In one embodiment, performing data cleaning on the extracted employee data may include: determining first anomalous data in the extracted employee data; and deleting the first anomalous data from the extracted employee data to obtain the first anomaly-free data. The first anomalous data may include data that is difficult to collect and/or data which may be inaccurate (for example, the employee's residential address, whether the employee is from a dual-earner family, salary information, etc.).

In one embodiment, performing data conversion on the first anomaly-free data may include: converting data types of the first anomaly-free data; converting data semantics of the first anomaly-free data; converting a data granularity of the first anomaly-free data; and normalizing the first anomaly-free data. Converting data types of the first anomaly-free data may include: converting the first anomaly-free data of different types from different data sources into a compatible data type with a uniform format (such as a data type of “date”).

Converting data semantics of the first anomaly-free data may include: performing semantic analysis on a fact table of the first anomaly-free data from each data source according to a dimension table of the data source, and parsing fields in fact tables of the first anomaly-free data from all data sources into a universal type of business analysis language.

Converting a data granularity of the first anomaly-free data may include: aggregating detail data of the first anomaly-free data from each data source to increase the data granularity of the first anomaly-free data.

Normalizing the first anomaly-free data may include: converting each parameter in the first anomaly-free data with different dimensions to a same dimension.

In one embodiment, performing data loading on the converted employee data may include: saving the converted employee data to a preset data warehouse. The preset data warehouse may be a storage device of the computing device.

In one embodiment, performing time-series correlation analysis on the loaded employee data may include: establishing a correlation between the converted employee data according to a time series correlation principle of per employee and per day. The computing device may use each type of data in converted employee data of each employee as a factor, and establish a time series association among factors of the employee. The time series association includes a relationship between data of a current day and data of previous days (for example, previous 2 days). For example, performing time-series correlation analysis on loaded employee data of employee A to obtain information of employee A, such as age, gender, overtime hours of today, no overtime of yesterday, overtime hours of the day before yesterday, not late today, late yesterday, day after payday, not resigning.

In one embodiment, performing feature coding on the analyzed employee data to obtain the first processed employee data may include: assigning values to the analyzed employee data according to a preset encoding rule; and setting weights to the factors. For example, the computing device assigns the basic salary of each employee to a value within (0,1). The higher the basic salary, the greater the value and the weight.

In one embodiment, the computing device selects the training set and the first verification set from the first processed employee data. The first verification set may correspond to a first time period. The first time period may denote when the preset data source recorded the original employee data. For example, the computing device selects first processed employee data from Aug. 1, 2018 to Aug. 21, 2018 as the training set, and selects first processed employee data from Aug. 22, 2018 to Aug. 30, 2018 as the first verification set. That is, the first time period is from Aug. 22, 2018 to Aug. 30, 2018.

In block S3, the computing device uses the training set to train a machine learning model to obtain a turnover estimation model.

In one embodiment, the turnover estimation model may be a logistic regression model, a random forest model, a naive Bayes model, a Boosting model, or a Markov model.

In block S4, the computing device uses the first verification set to verify the turnover estimation model to obtain a first estimation result.

In one embodiment, using the first verification set to verify the turnover estimation model to obtain a first estimation result may include: inputting the first verification set into the turnover estimation model to obtain the first estimation result. The first estimation result corresponds to the first time period.

The first estimation result may include a first estimated number of resigning employees per day in the first time period and an estimated resignation status of each employee. The estimated resignation status of the employee may be resigning or not resigning. If the employee is estimated to resign, the estimated resignation status of the employee is resigning. If the employee is estimated not to resign, the estimated resignation status of the employee is not resigning. It should be noted that the first estimated number of resigning employees is obtained by analyzing all employees, and the estimated resignation status is obtained by analyzing each employee.

For example, on Aug. 22, 2018, a total number of employees is 1,000, the first estimated number of resigning employees is 8. On Aug. 22, 2018, an estimated resignation status of employee A is not resigning. On Aug. 23, 2018, the estimated resignation status of employee A is resigning.

In one embodiment, the computing device may obtain the total number of employees per day in the first time period from the first processed employee data, and according to the first estimated number of resigning employees and the total number of employees per day in the first time period, calculate a first estimated number of not-resigning employees per day in the first time period.

In block S5, the computing device optimizes the turnover estimation model according to the first estimation result to obtain an optimized turnover estimation model.

In one embodiment, the computing device obtains an actual number of resigning employees per day in the first time period (for example, the first time period is from Aug. 22, 2018 to Aug. 30, 2018, actual number of resigning employees on Aug. 22, 2018 being 5) from the first processed employee data, and calculates a second estimated number of resigning employees per day in the first time period according to the estimated resignation status of each employee per day in the first time period. For example, on Aug. 22, 2018, an estimated resignation status of 5 employees is resigning, so the second estimated number of resigning employees is 5.

In one embodiment, the computing device may compare the first estimated number of resigning employees per day in the first time period with the actual number of resigning employees to obtain a first comparison result. The first comparison result may include a first error rate per day in the first time period. A formula for calculating the first error rate may be: first error rate=(the first estimated number of resigning employees per day in the first time period—the actual number of resigning employees per day in the first period of time)/the actual number of resigning employees per day in the first period of time×100%. For example, the first error rate on Aug. 22, 2018 is calculated as (8−5)/5×100%=60.00%.

In one embodiment, the computing device may compare the first estimated number of resigning employees and the second estimated number of resigning employees per day in the first time period to obtain a second comparison result. The second comparison result may include a second error rate of each day in the first time period. A formula for calculating the second error rate may be: second error rate=(the first estimated number of resigning employees per day in the first time period—the second estimated number of resigning employees per day in the first time period)/the first estimated number of resigning employees per day in the first time period×100%. For example, on Aug. 22, 2018, the second error rate is calculated as (5−5)/5×100%=0.00%.

In one embodiment, the computing device may use a line chart to visually compare the first estimated number of resigning employees, the actual number of resigning employees, and the second estimated number of resigning employees per day in the first time period. The computing device may fit a first fitting curve according to the first estimated number of resigning employees per day in the first time period, fit a second fitting curve according to the actual number of resigning employees per day in the first time period, and fit a third fitting curve according to the second estimated number of resigning employees per day in the first time period. The computing device may draw the first fitting curve, the second fitting curve, and the third fitting curve first with different colors in a first rectangular coordinate system. A horizontal axis of the first rectangular coordinate system represents the first time period, and a vertical axis of the first rectangular coordinate system represents number of employees. For example, the computing device may draw the first fitting curve with blue in the first rectangular coordinate system, draw the second fitting curve with red in the first rectangular coordinate system, and draw the third fitting curve with yellow in the rectangular coordinate system. The horizontal axis of the first rectangular coordinate system represents the first time period, for example, Aug. 22, 2018 to Aug. 30, 2018. The vertical axis of the first rectangular coordinate system represents the number of employees. The computing device may also calculate a second estimated number of not resigning employees per day in the first time period according to the second estimated number of not-resigning employees and the total number of employees per day in the first time period. The computing device may also calculate the first estimated number of not-resigning employees, an actual number of not-resigning employees, and the second estimated number of not-resigning employees per day in the first time period, and use a line chart to enable comparison of the data as to employees more intuitively.

In one embodiment, the computing device determines second anomalous data in the first processed employee data according to the first comparison result and the second comparison result. The second anomalous data may include overfitting data, and the overfitting data may include data that makes the first error rate and/or the second error rate too high (for example, more than 15%). For example, data of employees absent from work for multiple consecutive days, and data of resignation on holidays.

In one embodiment, the computing device performs second data processing on the first processed employee data to obtain target employee data. Performing second data processing may include: deleting and/or correcting the second anomalous data in the first processed employee data to obtain second anomaly-free data; and using the second anomaly-free data as the target employee data. Correcting the second anomalous data may include reducing or increasing a weight of a factor in the second anomalous data.

In one embodiment, the computing device may select a deep neural network model according to the first comparison result and the second comparison result, and optimize the turnover estimation model according to the target employee data and the deep neural network model. The deep neural network model may be a multilayer perceptron (MLP) model, a recurrent neural networks (RNN) model, or a one-dimensional convolutional neural network (CNN-1D) model. In this embodiment, the computing device may select the CNN-1D as the deep neural network model. Optimizing the turnover estimation model according to the target employee data and the deep neural network model may include: using a residual module of the CNN-1D to perform a lightweight processing on the turnover estimation model, and modifying an original activation function of a first layer of the turnover estimation model to a target activation function. For example, the original activation function change is a rectified linear unit (ReLU), and the target activation function is a sigmoid function. In the lightweight processing, all convolutional layers of the turnover estimation model are changed to a residual structure except for a first layer and a last layer of the turnover estimation model.

In block S6, the computing device obtains updated employee data of a second time period from the preset data source, and using the optimized turnover estimation model to process the updated employee data to obtain an employee turnover rate of the second time period.

In one embodiment, the updated employee data includes data of the second time period in the preset data source. The computing device performs the first data processing and the second data processing on the updated employee data to obtain updated target employee data, inputs the updated target employee data into the optimized turnover estimation model to obtain an estimated number of resigning employees per day in the second time period, and calculates the employee turnover rate according to the estimated number of resigning employees per day in the second time period.

In block S7, the computing device displays the employee turnover rate on a display screen.

In one embodiment, the computing device establishes a visualization platform according to the data warehouse technology, and displays the employee turnover rate on the visualization platform.

FIG. 1 describes in detail the resignation estimation method of the present disclosure. Hardware architecture that implements the resignation estimation method is described in conjunction with FIG. 2.

It should be understood that the described embodiments are for illustrative purposes only, and are not limited by this structure in the scope of the patent disclosure.

FIG. 2 is a block diagram of a computing device implementing the method of estimating employee turnover rates in one embodiment of the present disclosure. The computing device 3 may include a storage device 31 and at least one processor 32. A computer program (such as a system of estimating employee turnover rates 30) may be stored in the storage device 31 and executable by the processor 32. The processor 32 may execute the computer program to implement the blocks in the method of estimating employee turnover rates described above, such as the blocks S1 to S7 in FIG. 1.

The computing device 3 may be a device that can perform processing according to preset or stored instructions, such as a desktop computer, a notebook, a palmtop computer, or a cloud server. Hardware of the computing device may include, but is not limited to, a microprocessor, an disclosure specific integrated circuit (ASIC), a field-programmable gate array (FPGA), a digital signal processor (DSP), an embedded device, etc.

Those skilled in the art will understand that computing device 3 is only an example, and does not constitute a limitation. Other examples of computing device 3 may include more or fewer components than shown in FIG. 2, or combine some components, or have different components.

The storage device 31 may be used to store the computer program, and the processor 32 implements the computing device by running or executing the computer program or module stored in the storage device 31 and calling up data stored in the storage device 31. The storage device 31 may include a storage program area and a storage data area. The storage program area may store an operating system, and programs required by at least one function, etc.; the storage data area may store data and the like created in the use of the computing device 3. In addition, the storage device 31 may include non-volatile memory, such as a hard disk, a memory, a plug-in hard disk, a smart memory card (SMC), a secure digital (SD) card, a flash memory card (Flash Card), at least one magnetic disk storage device, flash memory device, or other non-volatile solid state storage device.

The processor 32 may be a central processing unit (CPU) or other general-purpose processor, a digital signal processor (DSP), an disclosure specific integrated circuit (ASIC), a field-programmable gate array (FPGA) or other programmable logic device, a discrete gate, or a transistor logic device, or a discrete hardware component, etc. The processor 32 may be a microprocessor or any conventional processor. The processor 32 may be a control center of the computing device 3, and connect various parts of the entire computing device 3 by using various interfaces and lines.

In an exemplary embodiment, the computer program may be divided into one or more modules, and the one or more modules are stored in the storage device 31 and executed by the processor 32 to complete the method of estimating employee turnover rates of the present disclosure. The one or more modules can be a series of computer-readable instruction segments capable of performing specific functions, and the instruction segments are used to describe execution processes of the computer program in the computing device 3.

When the modules integrated in the computing device 3 are implemented in the form of software functional units and used as independent units, they can be stored in a non-transitory readable storage medium. According to this understanding, all or part of the processes in the methods of the above embodiments implemented by the present disclosure can also be completed by related hardware instructed by computer-readable instructions. The computer-readable instructions may be stored in a non-transitory readable storage medium. The computer-readable instructions, when executed by the processor, may implement the steps of the foregoing method embodiments. The computer-readable instructions include computer-readable instruction codes, and the computer-readable instruction codes can be source code, object code, an executable file, or in some other intermediate form. The non-transitory readable storage medium may include any entity or device capable of carrying the computer-readable instruction code, a recording medium, a U disk, a mobile hard disk, a magnetic disk, an optical disk, a computer memory, and a read-only memory (ROM).

Although not shown, the computing device 3 may also include a power source (such as a battery) for supplying power to various components. The power source may be logically connected to the at least one processor 32 through a power management device, so as to realize functions such as charging, discharging, and power consumption management. The power supply may also include any components such as one or more direct current or alternating current power supplies, recharging devices, power failure detection circuits, power converters or inverters, and power status indicators. The computing device 3 may also include various sensors, BLUETOOTH modules, WI-FI modules, etc.

In several embodiments provided in the preset disclosure, it should be understood that the disclosed computing device and method may be implemented in other ways. For example, the embodiments of the computing device described above are merely illustrative. For example, the units are only divided according to logical function, and there may be other manners of division in actual implementation.

The modules described as separate components may or may not be physically separated, and the components displayed as modules may or may not be physical modules, that is, may be located in one place, or may be distributed on multiple network elements. Some or all of the modules may be selected according to actual needs to achieve the purpose of the solution of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The above integrated modules implemented in the form of function modules may be stored in a storage medium. The above function modules may be stored in a storage medium, and include several instructions to enable a computing device (which may be a personal computer, server, or network device, etc.) or processor to execute the method described in the embodiment of the present disclosure.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but not to signify any particular order.

Finally, the above embodiments are only used to illustrate technical solutions of the present disclosure, and are not to be taken as restrictions on the technical solutions. Although the present disclosure has been described in detail with reference to the above embodiments, those skilled in the art should understand that the technical solutions described in one embodiments can be modified, or some of technical features can be equivalently substituted, and that these modifications or substitutions are not to detract from the essence of the technical solutions or from the scope of the technical solutions of the embodiments of the present disclosure.

We claim:

1. A method of estimating employee turnover rates, comprising:
obtaining original employee data from at least one preset data source;
performing first data processing on the original employee data to obtain first processed employee data, and selecting a training set and a first verification set from the first processed employee data;
using the training set to train a machine learning model to obtain a turnover estimation model;
using the first verification set to verify the turnover estimation model to obtain a first estimation result;
optimizing the turnover estimation model according to the first estimation result to obtain an optimized turnover estimation model; and
obtaining updated employee data of a second time period from the preset data source, and using the optimized turnover estimation model to process the updated employee data to obtain an employee turnover rate of the second time period.

2. The method of claim 1, performing first data processing on the original employee data to obtain first processed employee data comprising:
performing data extraction on the original employee data to obtain extracted employee data;
performing data cleaning on the extracted employee data to obtain first anomaly-free data;
performing data conversion on the first anomaly-free data to obtain converted employee data;
performing data loading on the converted employee data to obtain loaded employee data;
performing time-series correlation analysis on the loaded employee data to obtain analyzed employee data; and
performing feature coding on the analyzed employee data to obtain the first processed employee data.

3. The method of claim 2, performing data extraction on the original employee data comprising:
extracting data of preset types from the original employee data;
performing data cleaning on the extracted employee data comprising:
determining first anomalous data in the extracted employee data, and deleting the first anomalous data from the extracted employee data to obtain the first anomaly-free data;
performing data conversion on the first anomaly-free data comprising:
converting data types of the first anomaly-free data, converting data semantics of the first anomaly-free data, converting a data granularity of the first anomaly-free data, and normalizing the first anomaly-free data;
performing data loading on the converted employee data comprising:
saving the converted employee data to a preset data warehouse.

4. The method of claim 3, performing time-series correlation analysis on the loaded employee data comprising:
establishing a correlation between the converted employee data according to a time series correlation principle of per employee and per day; and
performing feature coding on the analyzed employee data to obtain the first processed employee data comprising:
assigning values to the analyzed employee data according to a preset encoding rule.

5. The method of claim 1, the turnover estimation model is a Boosting model.

6. The method of claim 1, using the first verification set to verify the turnover estimation model to obtain a first estimation result comprising:
inputting the first verification set into the turnover estimation model to obtain the first estimation result, the first estimation result comprising a first estimated number of resigning employees per day in a first time period and an estimated resignation status of each employee, and the estimated resignation status of the employee being resigning or not resigning.

7. The method of claim 6, optimizing the turnover estimation model according to the first estimation result to obtain an optimized turnover estimation model comprising:
obtaining an actual number of resigning employees per day in the first time period from the first processed employee data, and calculating a second estimated number of resigning employees per day in the first time period according to the estimated resignation status of each employee per day in the first time period;
comparing the first estimated number of resigning employees per day in the first time period with the actual number of resigning employees to obtain a first comparison result;
comparing the first estimated number of resigning employees and the second estimated number of resigning employees per day in the first time period to obtain a second comparison result;
performing second data processing on the first processed employee data according to the first comparison result and the second comparison result to obtain target employee data;
selecting a deep neural network model according to the first comparison result and the second comparison result, the deep neural network model comprising a one-dimensional convolutional neural network model; and
optimizing the turnover estimation model according to the target employee data and the deep neural network model.

8. The method of claim 7, performing second data processing comprising:
deleting and/or correcting the second anomalous data in the first processed employee data to obtain second anomaly-free data, and using the second anomaly-free data as the target employee data; and
using the optimized turnover estimation model to process the updated employee data to obtain an employee turnover rate of the second time period comprising:
performing the first data processing and the second data processing on the updated employee data to obtain updated target employee data, inputting the updated target employee data into the optimized turnover estimation model to obtain an estimated number of resigning employees per day in the second time period, and calculates the employee turnover rate according to the estimated number of resigning employees per day in the second time period.

9. A computing device comprising a processor and a storage device, and the processor executing computer-readable instructions stored in the storage device to implement the following method:
obtaining original employee data from at least one preset data source;
performing first data processing on the original employee data to obtain first processed employee data, and selecting a training set and a first verification set from the first processed employee data;
using the training set to train a machine learning model to obtain a turnover estimation model;
using the first verification set to verify the turnover estimation model to obtain a first estimation result;
optimizing the turnover estimation model according to the first estimation result to obtain an optimized turnover estimation model; and
obtaining updated employee data of a second time period from the preset data source, and using the optimized turnover estimation model to process the updated employee data to obtain an employee turnover rate of the second time period.

10. The computing device of claim 9, performing first data processing on the original employee data to obtain first processed employee data comprising:
performing data extraction on the original employee data to obtain extracted employee data;
performing data cleaning on the extracted employee data to obtain first anomaly-free data;
performing data conversion on the first anomaly-free data to obtain converted employee data;
performing data loading on the converted employee data to obtain loaded employee data;
performing time-series correlation analysis on the loaded employee data to obtain analyzed employee data; and
performing feature coding on the analyzed employee data to obtain the first processed employee data.

11. The computing device of claim 10, performing data extraction on the original employee data comprising:
extracting data of preset types from the original employee data;
performing data cleaning on the extracted employee data comprising:
determining first anomalous data in the extracted employee data, and deleting the first anomalous data from the extracted employee data to obtain the first anomaly-free data;
performing data conversion on the first anomaly-free data comprising:
converting data types of the first anomaly-free data, converting data semantics of the first anomaly-free data, converting a data granularity of the first anomaly-free data, and normalizing the first anomaly-free data;
performing data loading on the converted employee data comprising:
saving the converted employee data to a preset data warehouse.

12. The computing device of claim 11, performing time-series correlation analysis on the loaded employee data comprising:
establishing a correlation between the converted employee data according to a time series correlation principle of per employee and per day; and
performing feature coding on the analyzed employee data to obtain the first processed employee data comprising:
assigning values to the analyzed employee data according to a preset encoding rule.

13. The computing device of claim 9, using the first verification set to verify the turnover estimation model to obtain a first estimation result comprising:
inputting the first verification set into the turnover estimation model to obtain the first estimation result, the first estimation result comprising a first estimated number of resigning employees per day in a first time period and an estimated resignation status of each employee, and the estimated resignation status of the employee being resigning or not resigning.

14. The computing device of claim 13, optimizing the turnover estimation model according to the first estimation result to obtain an optimized turnover estimation model comprising:
obtaining an actual number of resigning employees per day in the first time period from the first processed employee data, and calculating a second estimated number of resigning employees per day in the first time period according to the estimated resignation status of each employee per day in the first time period;
comparing the first estimated number of resigning employees per day in the first time period with the actual number of resigning employees to obtain a first comparison result;
comparing the first estimated number of resigning employees and the second estimated number of resigning employees per day in the first time period to obtain a second comparison result;
performing second data processing on the first processed employee data according to the first comparison result and the second comparison result to obtain target employee data;
selecting a deep neural network model according to the first comparison result and the second comparison result, the deep neural network model comprising a one-dimensional convolutional neural network model; and
optimizing the turnover estimation model according to the target employee data and the deep neural network model.

15. A non-transitory storage medium having stored thereon computer-readable instructions that, when the computer-readable instructions are executed by a processor to implement the following method:
obtaining original employee data from at least one preset data source;
performing first data processing on the original employee data to obtain first processed employee data, and selecting a training set and a first verification set from the first processed employee data;
using the training set to train a machine learning model to obtain a turnover estimation model;
using the first verification set to verify the turnover estimation model to obtain a first estimation result;
optimizing the turnover estimation model according to the first estimation result to obtain an optimized turnover estimation model; and
obtaining updated employee data of a second time period from the preset data source, and using the optimized turnover estimation model to process the updated employee data to obtain an employee turnover rate of the second time period.

16. The non-transitory storage medium of claim 15, performing first data processing on the original employee data to obtain first processed employee data comprising:
performing data extraction on the original employee data to obtain extracted employee data;
performing data cleaning on the extracted employee data to obtain first anomaly-free data;
performing data conversion on the first anomaly-free data to obtain converted employee data;
performing data loading on the converted employee data to obtain loaded employee data;
performing time-series correlation analysis on the loaded employee data to obtain analyzed employee data; and
performing feature coding on the analyzed employee data to obtain the first processed employee data.

17. The non-transitory storage medium of claim 16, performing data extraction on the original employee data comprising:
extracting data of preset types from the original employee data;
performing data cleaning on the extracted employee data comprising:
determining first anomalous data in the extracted employee data, and deleting the first anomalous data from the extracted employee data to obtain the first anomaly-free data;
performing data conversion on the first anomaly-free data comprising:
converting data types of the first anomaly-free data, converting data semantics of the first anomaly-free data, converting a data granularity of the first anomaly-free data, and normalizing the first anomaly-free data;
performing data loading on the converted employee data comprising:
saving the converted employee data to a preset data warehouse.

18. The non-transitory storage medium of claim 17, performing time-series correlation analysis on the loaded employee data comprising:
establishing a correlation between the converted employee data according to a time series correlation principle of per employee and per day; and
performing feature coding on the analyzed employee data to obtain the first processed employee data comprising:
assigning values to the analyzed employee data according to a preset encoding rule.

19. The non-transitory storage medium of claim 15, using the first verification set to verify the turnover estimation model to obtain a first estimation result comprising:
inputting the first verification set into the turnover estimation model to obtain the first estimation result, the first estimation result comprising a first estimated number of resigning employees per day in a first time period and an estimated resignation status of each employee, and the estimated resignation status of the employee being resigning or not resigning.

20. The non-transitory storage medium of claim 19, optimizing the turnover estimation model according to the first estimation result to obtain an optimized turnover estimation model comprising:
obtaining an actual number of resigning employees per day in the first time period from the first processed employee data, and calculating a second estimated number of resigning employees per day in the first time period according to the estimated resignation status of each employee per day in the first time period;
comparing the first estimated number of resigning employees per day in the first time period with the actual number of resigning employees to obtain a first comparison result;
comparing the first estimated number of resigning employees and the second estimated number of resigning employees per day in the first time period to obtain a second comparison result;
performing second data processing on the first processed employee data according to the first comparison result and the second comparison result to obtain target employee data;
selecting a deep neural network model according to the first comparison result and the second comparison result, the deep neural network model comprising a one-dimensional convolutional neural network model; and
optimizing the turnover estimation model according to the target employee data and the deep neural network model.
